(19) United States
(12) Patent Application Publication
(10) Pub. No.: US 2013/0057712 A1
(43) Pub. Date: Mar. 7, 2013

(54) SIGNAL TRANSMITTING DEVICE, SIGNAL TRANSMITTING METHOD, SIGNAL RECEIVING DEVICE, SIGNAL RECEIVING METHOD AND SIGNAL TRANSMITTING SYSTEM

(71) Applicant: Shigeyuki YAMASHITA, Kanagawa (JP)

(72) Inventor: Shigeyuki YAMASHITA, Kanagawa (JP)

(21) Appl. No.: 13/592,603

(22) Filed: Aug. 23, 2012

(30) Foreign Application Priority Data
Sep. 1, 2011 (JP) 2011-190549

(51) Int. Cl. H04N 9/65; H04N 5/225

(52) U.S. Cl. 348/207.99; 348/642; 348/E05.024; 348/E09.045

(57) ABSTRACT

There is provided a signal transmitting device including a word puncturing controller configured to puncture per word a 1 ch 16-bit signal including 4:4:4 of r:g:b and including G, B and R signals of all samples, and map a 1 ch 16 bit-signal including 4:2:2 of r:g:b and including a G signal of all samples and B and R signals of even samples, and a 1 ch 16-bit signal including 0:2:2 of r:g:b and including B and R signals of odd samples without a G signal, a mapping controller, and a reading controller.

### BACKGROUND

The present disclosure relates to, for example, a signal transmitting device, a signal transmitting method, a signal receiving device, a signal receiving method and a signal transmitting system which are suitable for use in transmitting a 16 bit video signal output from an image sensor.

In the past, standardizations have been established to transmit a HD (High Definition) signal which is a video signal of one frame output from an image sensor including 1920 samples×1080 lines (hereinafter, m samples×n lines are abbreviated as “m×n”). As international institutions which establish these standardizations, ITU (International Telecommunication Union) and SMPTE (Society of Motion Picture and Television Engineers) are known.

According to, for example, SMPTE274M, a sample structure of a video signal of 1920×1080 is defined, and, according to SMPTE292M, a serial digital interface of a HDTV system is defined. Further, according to SMPTE372M, a dual link HD-SDI interface using Links A and B is defined using the data structure defined according to SMPTE292M as a base. In the following description, “1920×1080” or “2048×1080” is also referred to as “2 k”, and “3840×2160” or “4096×2160” is also referred to as “4 k” or “4 k×2 k”. Further, a HD-SDI interface which can transmit a video signal at 1.5 Gbps is also referred to as “1.5 G-SDI”.

Meanwhile, sample structures of pixels according to a 4096 standard or a 3840 standard defined according to SMPTE2048-1 or SMPTE2036-1 (UHDTV) include the following two types illustrated in FIG. 14.

FIG. 14 is an explanatory view illustrating an example of a sample structure of a 4 k standard.

Frames used to describe FIGS. 14A and 14B form one frame with a sample structure of 4 k×2 k. The sample structures of the 4 k standard include the following three types. In addition, signals such as R′, G′ and B′ with dashes “′” in the SMPTE standard refer to signals which are, for example, gamma corrected.

FIG. 14A illustrates an example of a pixel sample of the R′ G′ B′ and Y′ Cb′ Cr′ 4:4:4 system. With this system, a RGB or YCbCr component is included in all samples.

FIG. 14B illustrates an example of a pixel sample of a Y′ Cb′ Cr′ 4:2:2 system. With this system, YCbCr components are included in even samples, and Y components are included in odd samples.

Further, Japanese Patent Application Laid-Open No. 2005-328494 discloses a technique of transmitting 3840×2160/30 P and 30/1.001 P/4:4:4/12-bit signals which are one type of a super-high-resolution signal of 4 k×2 k at a bit rate equal to or more than 10 Gbps. In addition, when [3840×2160/30 P] is indicated, [the number of pixel samples in the horizontal direction]×[the number of lines in the vertical direction]/[the number of frames per second] is indicated. Further, [4:4:4] indicates the ratio of [red signal R:green signal G:blue signal B] in case of a primary color signal transmission scheme, and indicates the ratio of [brightness signal Y:first color difference signal Cb:second color difference signal Cr] in case of a color difference signal transmission scheme.

### SUMMARY

By the way, a transmission standard in related art defined according to SMPTE postulates that a 10 bit or 12 bit video signal is transmitted using HD-SDI of 10 bits/word. However, in recent years, it is increasingly demanded to transmit a 16 bit video signal output from an image sensor, using HD-SDI of 10 bits/word. A 16 bit video signal is, for example, a 2 k/4:4:4/16-bit signal, and this signal includes a G signal, a B signal and a R signal of 2 k samples. However, such an interface or an interface data standardization for transmitting a video signal of 2 k/23.98 P-60 P/16 bits have not been proposed.

In light of this situation, it is desirable to provide an interface for transmitting a 16 bit video signal output from an image sensor.

The present disclosure includes: when a video signal output from an image sensor is defined according to m×n (where m and n refer to m samples×n lines)/a−b (where a and b refer to frame rates)/r:g:b (where r, g and b refer to signal ratios in case of a predetermined signal transmission scheme)/16-bit signal, and each bit of a G signal of all samples included in a 1 ch 16-bit signal is G0, G1, . . . and G15, each bit of a B signal is B0, B1, . . . and B15 and each bit of a R signal is R0, R1, . . . and R15, puncturing per word the 1 ch 16-bit signal including 4:4:4 of r:g:b and including the G, B and R signals of all samples, and mapping a 1 ch 16-bit signal including 4:2:2 of r:g:b and including a G signal of all samples and B and R signals of even samples, and a 1 ch 16-bit signal including 0:2:2 of r:g:b and including B and R signals of odd samples without a G signal.

Next, the present disclosure includes: mapping the 1 ch 16-bit signal punctured per word and including 4:2:2 of r:g:b, on first and second HD-SDI including 2 ch 10-bit signals including 4:2:2 of r:g:b according to a first mapping structure, mapping a 1 ch 16-bit signal punctured per word and including 0:2:2 of r:g:b, on third HD-SDI including a 1 ch 10-bit signal including 4:2:2 of r:g:b according to a second mapping structure, and outputting the first to third HD-SDI.

Further, the present disclosure includes, when a video signal output from an image sensor is defined according to m×n (where m and n refer to m samples×n lines)/a−b (where a and b refer to frame rates)/r:g:b (where r, g and b refer to signal ratios in case of a predetermined signal transmission scheme)/16-bit signal, and each bit of a G signal of all samples included in a 1 ch 16-bit signal is G0, G1, . . . and G15, each bit of a B signal is B0, B1, . . . and B15 and each bit of a R signal is R0, R1, . . . and R15, writing first to third HD-SDI including 3 ch 10-bit signals including 4:2:2 of r:g:b, in a memory.

Next, the present disclosure includes: extracting the 1 ch 16-bit signal including 4:2:2 of r:g:b and including a G signal of all samples and B and R signals of even samples, from the first and second HD-SDI including 2 ch 10-bit signals read from the memory according to a first mapping structure, and extracting a 1 ch 16-bit signal including 0:2:2 of r:g:b and including B and R signals of odd samples without a G signal, from third HD-SDI including a 1 ch 10-bit signal including 4:2:2 of r:g:b according to a second mapping structure.

Further, the present disclosure includes generating the 1 ch 16-bit signal including 4:4:4 of r:g:b and including G, B and R signals of all samples by multiplexing per word the 1 ch 16-bit signal including 4:2:2 of r:g:b and the 1 ch 16-bit signal including 0:2:2 of r:g:b.

By this means, it is possible to map a 16 bit video signal output from an image sensor on existing HD-SDI and transmit the video signal.

According to the present disclosure, it is possible to transmit a 16 bit video signal output from an image sensor as first to third HD-SDI including 10-bit signals including 4:2:2 of r:g:b based on the first and second mapping structures. Consequently, it is possible to transmit 16 bit video signal according to an existing transmission standard.

### BRIEF DESCRIPTION OF THE DRAWINGS

FIG. 1 is a view illustrating an entire configuration of a signal transmitting system for a television broadcasting station according to a first embodiment of the present disclosure;

FIG. 2 is a block diagram illustrating an internal configuration example of a signal transmitting device according to a first embodiment of the present disclosure;

FIG. 3 is an explanatory view illustrating examples of a normal bayer structure and a double bayer structure;

FIG. 4 is an explanatory view illustrating a data structure example of one line of 1.5 Gbps HD-SDI (serial/digital data);

FIG. 5 is an explanatory view illustrating a schematic example of processing of performing word puncturing and mapping control of a 1 ch 2 k/23.98 P-30 P or 47.95I-60I/4:4:4/16-bit signal according to the first embodiment of the present disclosure;

FIG. 6 is an explanatory view illustrating an example of transmission representation of a dual link;

FIG. 7 is an explanatory view illustrating an example of a first mapping structure which is referred to when a 30 P or 60I/4:2:2/16-bit signal is mapped on 2 ch (dual link) 1.5 G-SDI according to the first embodiment of the present disclosure;

FIG. 8 is an explanatory view illustrating an example of a second mapping structure which is referred to when a 30 P or 60I/0:2:2/16-bit signal is mapped on 1.5 G-SDI according to the first embodiment of the present disclosure;

FIG. 9 is a block diagram illustrating an internal configuration example of a signal receiving device according to the first embodiment of the present disclosure;

FIG. 10 is a block diagram illustrating an internal configuration example of a signal transmitting device according to a second embodiment of the present disclosure;

FIG. 11 is an explanatory view illustrating a schematic example of processing of performing line puncturing, word puncturing and mapping control of a 2 k/47.95 P-60 P/4:4:4/16-bit signal according to the second embodiment of the present disclosure;

FIG. 12 is an explanatory view illustrating an example of line puncturing;

FIG. 13 is a block diagram illustrating an internal configuration example of a signal receiving device according to the second embodiment of the present disclosure; and

FIG. 14 is an explanatory view illustrating an example of a sample structure of a UHDTV standard.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted. In addition, the embodiments will be described in the following order of 1. First Embodiment (an example where a 2 k/23.98 P-30 P or 47.95I-60I/4:4:4/16-bit signal is mapped on 1.5 G-SDI 3 ch and is transmitted), 2. Second Embodiment (an example where a 2 k/47.95 P-60 P/4:4:4/16-bit signal is mapped on 1.5 G-SDI 6 ch and is transmitted), and 3. Modified Example.

### 1. First Embodiment

### An Example Where a 2 k/23.98 P-30 P or 47.95I-60I/4:4:4/16-bit Signal is Mapped on 1.5 G-SDI 3 ch and is Transmitted

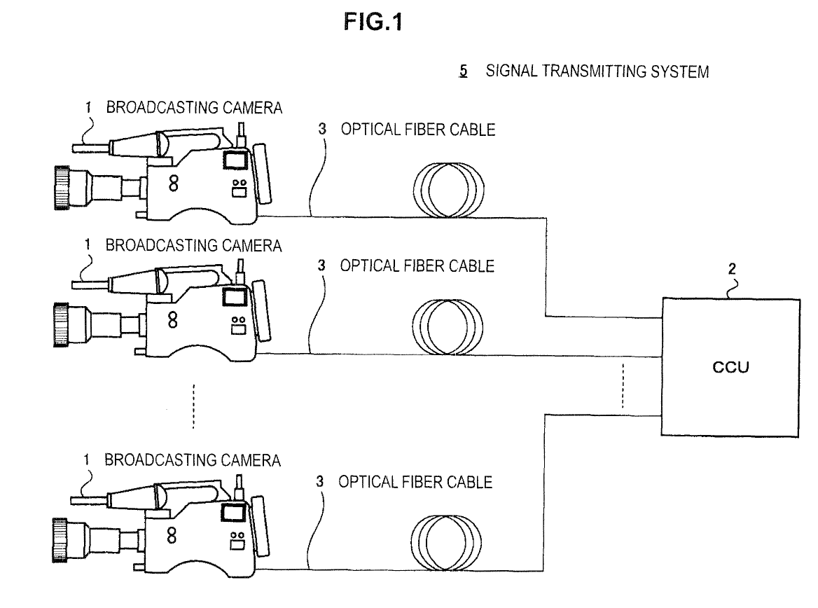

First, the first embodiment of the present disclosure will be described with reference to FIGS. 1 to 9.

A signal transmitting device 10 according to the first embodiment of the present disclosure realizes a signal transmitting method performed by internal blocks in cooperation by executing a program. First, a configuration example of the signal transmitting device 10 will be described.

Hereinafter, an example will be described where a 2 k/23.98 P-30 P or 47.95I-60I/4:4:4/16-bit signal is mapped on 1.5 G-SDI 3 ch and is transmitted.

A video signal output from an image sensor which is not illustrated is defined according to m×n (m and n refer to m samples×n lines)/a−b (a and b refer to frame rates)/r:g:b (r, g and b refer to signal ratios in case of a predetermined signal transmission scheme)/16 bits. In this case, m×n of a 1 ch 16-bit signal including 4:4:4 of r:g:b is 1920 samples×1080 lines or 2048 samples×1080 lines. Further, each bit of a G signal of all samples included in this 16-bit signal is G0, G1, . . . and G15, each bit signal of a B signal is B0, B1, . . . and B15, and each bit of a R signal is R0, R1, . . . and R15.

Furthermore, when a−b is 23.98 P,24 P,25 P,29.97 P,30 P, a−b is abbreviated as “23.98 P-30 P” in some cases. Still further, when a−b is 47.95I,48I,50I,59.94I,60I, a−b is abbreviated as “47.95I-60I” in some cases. Moreover, for example, a “2 k/23.98 P-30 P or 47.95I-60I/4:4:4/16-bit signal” has the following meaning. That is, this means that the image sensor includes 1920×1080 or 2048×1080 pixels, a frame rate of the video signal is 23.98 P-30 P or a field rate is 47.95I-60I, and quantization bits of the video signal output from the pixels are 16 bits.

FIG. 1 is a view illustrating an entire configuration of a signal transmitting system 5 for a television broadcasting station to which the present embodiment is applied.

This signal transmitting system 5 includes a plurality of broadcasting cameras 1 and a CCU (camera control unit) 2, and each broadcasting camera 1 is connected to the CCU 2 through an optical fiber cable 3. The broadcasting camera 1 is used as a signal transmitting device to which a signal transmitting method of transmitting a serial/digital signal is applied, and the CCU 2 is used as a signal receiving device to which a signal receiving method of receiving a serial/digital signal is applied. Further, the signal transmitting system 5 in which the broadcasting cameras 1 and the CCU 2 are combined is known as a signal transmitting system which transmits and receives serial/digital signals.

A plurality of broadcasting cameras 1 employ the same configuration. Further, the broadcasting camera 1 functions as a signal transmitting device which generates and transmits a digital cinema 2 k/23.98 P-30 P or 47.95I-60I/4:4:4/16-bit signal, to the CCU 2.

The CCU 2 is a unit which controls each broadcasting camera 1, receives a video signal from each broadcasting camera 1 and transmits a video signal (return video) for displaying a video image which is being captured by another broadcasting camera 1, on a monitor of each broadcasting camera 1. The CCU 2 functions as a signal receiving device which receives a video signal from each broadcasting camera 1.

### DWDM/CWDM Wavelength Multiplex Transmitting Technique

Hereinafter, the DWDM/CWDM wavelength multiplex transmitting technique will be described.

A method of multiplexing and transmitting lights of a plurality of wavelengths is referred to as “WDM (Wavelength Division Multiplexing)”. The WDM is roughly classified into three systems according to wavelength intervals.

(1) 2 Wavelength Division Multiplexing System

The 2 wavelength multiplexing system is a system of multiplexing and transmitting about two to three waves such as 1.3 μm and 1.55 μm through one optical fiber.

(2) DWDM (Dense Wavelength Division Multiplexing) System

A method of multiplexing and transmitting light highly densely at intervals of about 0.2 nm, 0.4 nm, 0.8 nm and . . . at wavelengths of 25 GHz, 50 GHz, 100 GHz, 200 GHz and . . . at a frequency of light in a 1.55 μm band in particular is called DWDM. A center wavelength and other wavelengths are standardized according to ITU-T (International Telecommunication Union Telecommunication standardization sector). According to DWDM, a wavelength interval is 100 GHz and is narrow, so that it is possible to perform several tens to hundreds of multiplexing, and perform communication of a ultrahigh capacity. However, it is necessary that an oscillation wavelength width be sufficiently narrower than 100 GHz of the wavelength interval, and that a temperature of a semiconductor layer be controlled such that the center wavelength matches the ITU-T standard, and therefore devices are costly and the system consumes large power.

(3) CWDM (Coarse Wavelength Division Multiplexing) System

By contrast with this, in recent years, a wavelength multiplexing technique referred to as “CWDM” which secures 10 nm to 20 nm of the wavelength interval which is one digit or more than DWDM is gaining attention. The wavelength interval is comparatively wide, and the oscillation wavelength width of a semiconductor laser does not have to be a narrow band as in DWDM and the temperature of the semiconductor laser does not have to be controlled, so that it is possible to reduce cost of the system and reduce power consumption. CWDM is effective for the system which does not use the large capacity as in DWDM. An example of the center wavelength generally employs a 4 ch configuration or less at the moment. The center wavelength employs, for example, 1.511 μm, 1.531 μm, 1.551 μm and 1.571 μm, and employs a 8 ch configuration including 1.471 μm, 1.491 μm, 1.511 μm, 1.531 μm, 1.551 μm, 1.571 μm, 1.591 μm and 1.611 μm.

### Internal Configuration Example of Signal Transmitting Device 10

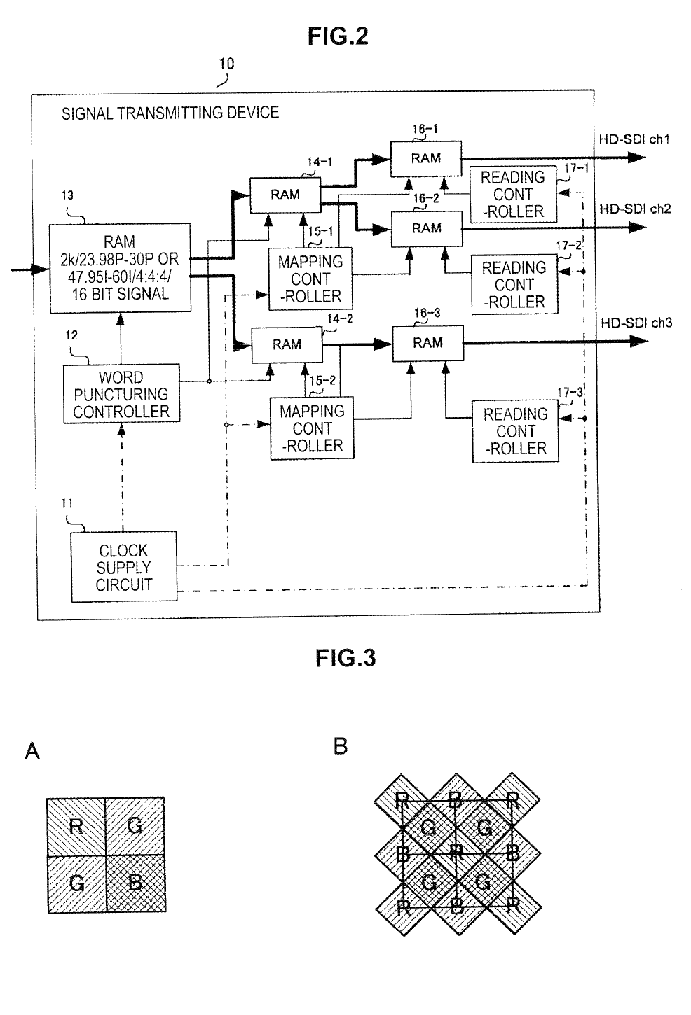

FIG. 2 illustrates an internal configuration example of the signal transmitting device 10.

The broadcasting camera 1 according to the first embodiment of the present disclosure has the signal transmitting device 10 which multiplexes a 2 k/23.98 P-30 P or 47.95I-60I/4:4:4/16-bit signal on 3 ch HD-SDI, and outputs the signal to the signal receiving device 20 of the CCU 2.

The signal transmitting device 10 has a clock supply circuit 11 which supplies a clock to each unit, and a RAM 13 which stores a 2 k/23.98 P-30 P or 47.95I-60I/4:4:4/16-bit signal output from the image sensor which is not illustrated. Further, the signal transmitting device 10 has a word puncturing controller 12 which controls word puncturing of data read from the RAM 13, and RAMs 14-1 and 14-2 which data word-punctured by the word puncturing controller 12 are written.

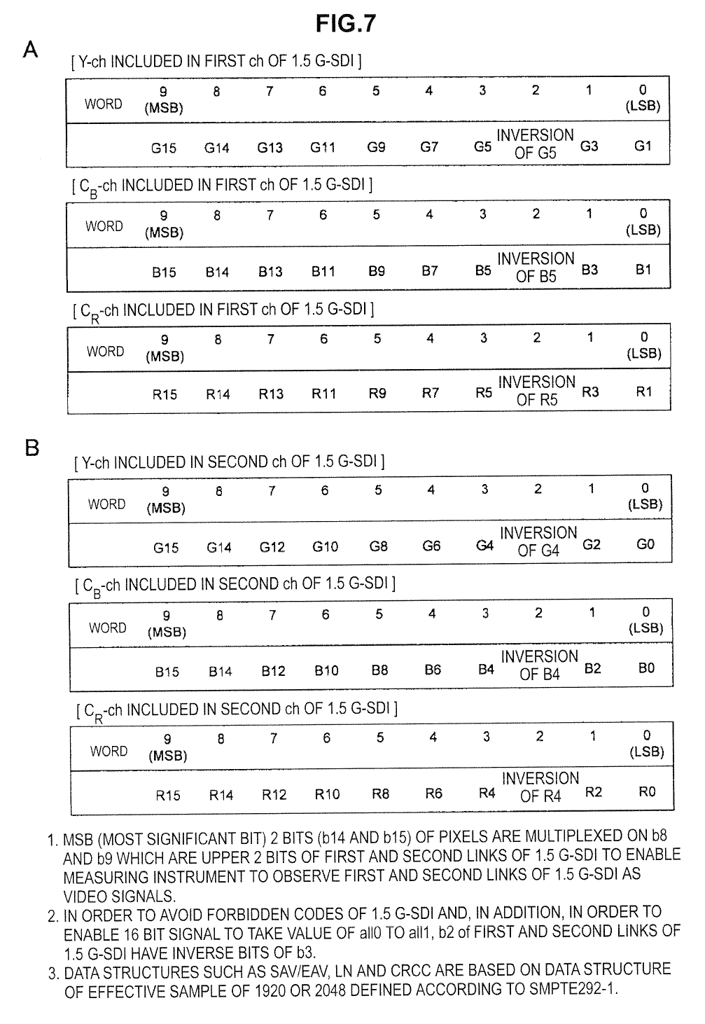

Furthermore, the signal transmitting device 10 has a mapping controller 15-1 which maps the 2 k/23.98 P-30 P or 47.95I-60I/4:2:2/16-bit signal read from the RAM 14-1 according to a first mapping structure (see FIG. 7) which will be described below. Still further, the signal transmitting device 10 has RAMs 16-1 and 16-2 which store 2 ch 2 k/23.98 P-30 P or 47.95I-60I/4:2:2/10-bit signals mapped by the mapping controller 15-1.

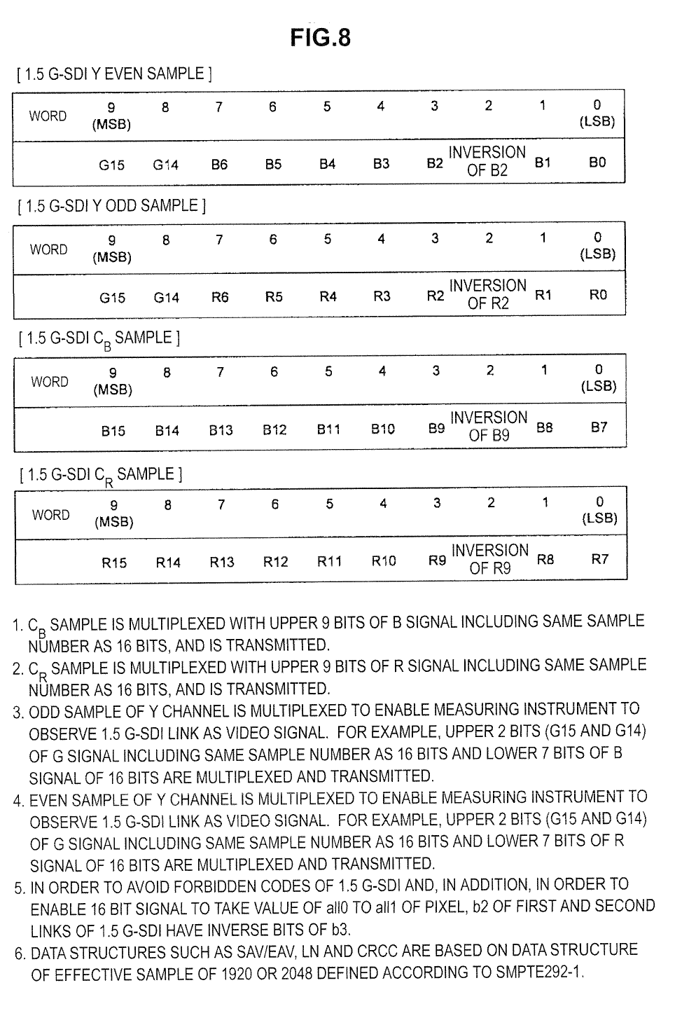

Moreover, the signal transmitting device 10 has a mapping controller 15-2 which maps the 2 k/23.98 P-30 P or 47.95I-60I/0:2:2/16-bit signal read from the RAM 14-2 according to a second mapping structure (See FIG. 8) which will be described below. Further, the signal transmitting device 10 has a RAM 16-3 which stores a 1 ch 2 k/23.98 P-30 P or 47.95I-60I/4:2:2/10 mapped by the mapping controller 15-2.

Furthermore, the signal transmitting device 10 has reading controllers 17-1 to 17-3 which output pixel samples of data read from the RAMs 16-1 to 16-3 as the 3 ch HD-SDI.

Next, an operation example of each unit will be described.

The clock supply circuit 11 supplies clocks used for reading or writing pixel samples to the word puncturing controller 12, the mapping controllers 15-1 to 15-2 and the reading controllers 17-1 to 17-3. Each unit operates in synchronization with this supplied clock.

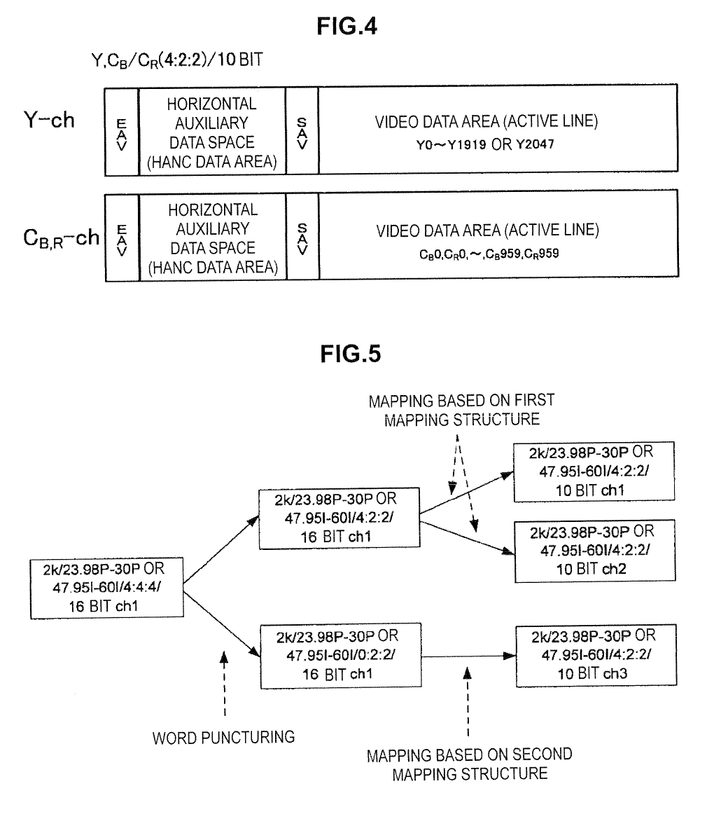

The word puncturing controller 12 performs word puncturing according to the same system as FIGS. 4, 6, 7, 8 and 9 of SMPTE372 using the pixel sample read from the RAM 13. In this case, the word puncturing controller 12 punctures per word a 1 ch 16-bit signal including 4:4:4 of r:g:b and including G, B and R signals of all samples. Further, the 1 ch 16-bit signal including 4:2:2 of r:g:b and including a G signal of all samples and B and R signals of even samples is mapped. Similarly, a 1 ch 16-bit signal including 0:2:2 of r:g:b and including the B and R signals of even samples without the G signal is mapped. In this case, the 1 ch 2 k/23.98 P-30 P or 47.95I-60I/4:2:2/16-bit signal is written in the RAM 14-1. Meanwhile, the 1 ch 2 k/23.98 P-30 P or 47.95I-60I/0:2:2/16-bit signal is written in the RAM 14-2.

Next, the mapping controller 15-1 maps the 1 ch 16-bit signal punctured per word and including 4:2:2 of r:g:b, on the first and second HD-SDI including 4:2:2 of r:g:b according to the first mapping structure (see FIG. 7 described below). The first and second HD-SDI include 2 ch 10-bit signals.

In this case, the mapping controller 15-1 maps the 2 k/23.98 P-30 P or 47.95I-60I/4:2:2/16-bit signal read from RAM 14-1, on the 2 ch 10-bit signals again, and writes the bit signal in the RAMs 16-1 and 16-2. In this case, in the RAM 16-1, a 1 ch 2 k/23.98 P-30 P or 47.95I-60I/4:2:2/10-bit signal extracted from odd bits of the 2 k/23.98 P-30 P or 47.95I-60I/4:2:2/16-bit signal is written. By contrast with this, in the RAM 16-2, the 1 ch 2 k/23.98 P-30 P or 47.95I-60I/4:2:2/10-bit signal extracted from even bits of the 2 k/23.98 P-30 P or 47.95I-60I/4:2:2/16-bit signal is written.

Meanwhile, the mapping controller 15-2 maps the 1 ch 16-bit signal punctured per word and including 0:2:2 of r:g:b, on third HD-SDI including 4:2:2 of r:g:b according to the second mapping structure (see FIG. 8 described below). This third HD-SDI includes the 1 ch 10-bit signal.

In this case, the mapping controller 15-2 maps the 2 k/23.98 P-30 P or 47.95I-60I/0:2:2/16-bit signal read from the RAM 14-2, on the 1 ch 2 k/23.98 P-30 P or 47.95I-60I/4:2:2/10-bit signal again, and writes the bit signal in the RAM 16-3.

In addition, a detailed operation example of the mapping controllers 15-1 and 15-2 will be described below.

Further, the reading controllers 17-1 to 17-3 output the first to third HD-SDI read from the RAMs 16-1 to 16-3 according to a reference clock supplied from the clock supply circuit 11 as HD-SDI ch 1 to ch 3.

In addition, with this example, processing of performing puncturing control at two stages using three types of memories (RAM13, RAMs 14-1 and 14-2, and RAMs 16-1 to 16-3) to perform word puncturing and mapping control has been described. However, after performing word puncturing and mapping control using one memory, the first to third HD-SDI may be output as 3 ch HD-SDI.

Meanwhile, a difference between a normal bayer structure and a double bayer structure of the image sensor which is not illustrated and which outputs a 16-bit signal of 4 k×2 k will be described. FIG. 3 illustrates an example of a video signal output from a pixel adopting a sample structure of 4 k×2 k of the double bayer structure.

In the past, an imaging device using an image sensor adopting a bayer structure is generally known. This image sensor takes in image light of a subject through a color filter, and outputs the video signal according to the intensity of the image light. Further, by applying predetermined processing to a video signal by a subsequent processor, the imaging device can display a video image on a view finder or an external display device. With the image sensor, R, G and B pixels which can output primary color signals such as R, G and B signals are generally arranged in a predetermined pattern, and the resolution varies depending on how R, G and B pixels are arranged.

FIG. 3A illustrates an example of the normal bayer structure.

The normal bayer structure employs a configuration where two G pixels are arranged on a diagonal line, and R and B pixels are arranged on a diagonal line orthogonal to this orthogonal line. However, with the normal bayer structure, G ch having the greatest number of pixels may not provide half the number of pixels of 4 k×2 k.

FIG. 3B illustrates an example of the double bayer structure.

With the double bayer structure, pixels adopting the normal bayer structure illustrated in FIG. 3A are aligned diagonally at 45 degrees. These pixels have a size which reduces the size vertically and horizontally into half compared to the pixels in the normal bayer structure. Hence, G ch in the double bayer has the resolution corresponding to the number of pixels of 4 k×2 k. Accordingly, although the size of one pixel becomes small, by aligning pixels diagonally, the size of one pixel does not have to be made small compared to a case where the normal bayer structure has the number of pixels of 4 k×2 k in G ch. Hence, it is possible to provide an advantage of keeping a good balance between the resolution and the sensitivity for the normal bayer structure.

Further, a converter which is not illustrated converts the 16-bit signal of 4 k×2 k output from the image sensor which adopts the double bayer structure of 4 k×2 k, into a 2 k 16-bit signal, and then transmits the video signal using the signal transmitting system 1 according to the present embodiment.

Next, a configuration example of serial data defined according to a HD-SDI format of one line will be described.

FIG. 4 illustrates a data configuration example of one line of HD-SDI (serial/digital data) of 1.5 Gbps.

Hereinafter, data structure examples of two types of channels of a Y channel and C_{B} and C_{R} channels will be described. A line number LN and an error detection code CRC included in each channel are included in EAV, a video data area (active line) and SAV. Further, horizontal auxiliary data space (HANC data area) including an area of additional data is described.

In addition, an audio signal is mapped on the horizontal auxiliary data space in some cases. In this case, the horizontal auxiliary data space is configured by adding auxiliary data to the audio signal to establish synchronization with a HD-SDI signal to be input.

FIG. 5 illustrates a schematic example of processing of performing word puncturing and mapping control of the 1 ch 2 k/23.98 P-30 P or 47.95I-60I/4:4:4/16-bit signal.

The 2 k/23.98 P-30 P or 47.95I-60I/4:4:4/16-bit signal adopts the same frame/line structure as 1920×1080 and 2048×1080/8 bit, 10 bit and 12-bit signals defined according to SMPTE274 or SMPTE2048-2. Further, the sample structure employs RGB (4:4:4), and the number of quantization bits is 16 bits. According to SMPTE274 or SMPTE2048-2, upper 8 bits defines all0 and all1 data as forbidden codes (codes which do not have to be allocated as a video code to use for a header of a SAV/EAV or ANC packet).

Upon quantization using 10 bits, forbidden codes are 000h to 003h and 3FCh to 3FFh, and, upon quantization using 12 bits, forbidden codes are 000h to 00Fh and FF0h to FFFh. Hence, when the same code as the forbidden code is also provided to a 16-bit signal quantized by 16 bits upon quantization by 10 bits or 12 bits, 0000h to 00FFh and FF00h to FFFFh are forbidden codes. This is not preferable because up to “512” codes which can be used as video signals are limited, and, therefore, representing a video signal using all0 to all1 will be studied.

As described above, under control of the word puncturing controller 12, the 1 ch 2 k/23.98 P-30 P or 47.95I-60I/4:4:4/16-bit signal read from the RAM 13 is word-punctured to 2 ch 16-bit signals. These 2 ch 16-bit signals are a 2 k/23.98 P-30 P or 47.95I-60I/4:2:2/16-bit signal and a 2 k/23.98 P-30 P or 47.95I-60I/0:2:2/16-bit signal.

Then, the mapping controller 15-1 maps the 1 ch 2 k/23.98 P-30 P or 47.95I-60I/4:2:2/16-bit signal on the 2 ch 2 k/23.98 P-30 P/4:2:2 or 47.95I-60I/10-bit signals. Further, the mapping controller 15-2 maps the 1 ch 2 k/23.98 P-30 P or 47.95I-60I/0:2:2/16-bit signal on the 1 ch 2 k/23.98 P-30 P or 47.95I-60I/4:2:2/10-bit signal.

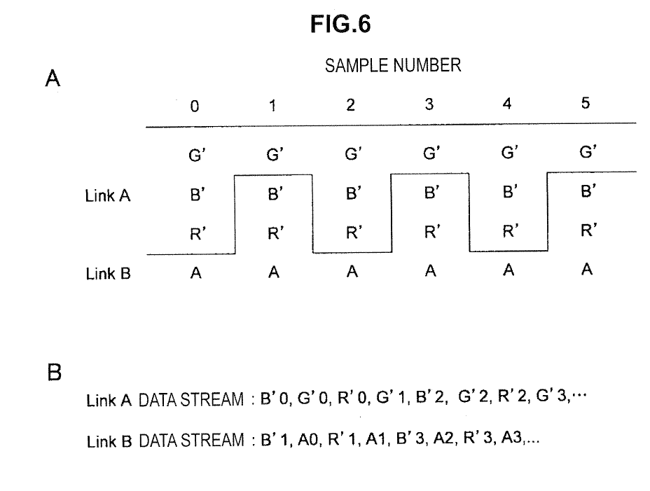

FIG. 6 illustrates an example of a mapping method for a dual link. FIG. 6A illustrates an example of transmission representation of Links A and B, and FIG. 6B illustrates an example of a transmission order of the Links A and B.

As illustrated in FIG. 6A, all samples of a G′ channel and samples of even numbers of B′ and R′ channels are transmitted through the Link A, and all samples of an A channel and samples of odd numbers of B′ and R′ channels are transmitted through the Link B.

More specifically, in each data stream of the Links A and B, samples are transmitted in the following order. In addition, as described above, R′, G′ and B′ signals with dashes “′” indicate R, G and B signals which are, for example, gamma corrected, and a number assigned to each signal indicates a sample number.

(1) Link A data stream: B′0, G′0, R′0, G′1, B′2, G′2, R′2, G′3, and . . .
(2) Link B data stream: B′1, A0, R′1, A1, B′3, A2, R′3, A3, and . . .

### Example of Mapping Structure

Next, examples of two types of mapping structures of 1.5 G-SDI will be described with reference to FIGS. 7 and 8.

### Example of First Mapping Structure

FIG. 7 illustrates an example of a first mapping structure which is referred to when a 1 ch 30 P or 60I/4:2:2/16-bit signal is mapped on 2 ch (dual link) 1.5 G-SDI. FIG. 7A illustrates examples of mapping structures of a Y channel, a C_{B} channel and a C_{R} channel included in the first HD-SDI of 1.5 G-SDI. FIG. 7B illustrates examples of mapping structures of the Y channel, the C_{B} channel and the C_{R} channel included in the second HD-SDI of 1.5 G-SDI.

As described above, the word puncturing controller 12 word-punctures a 4:4:4/16-bit signal based on FIG. 3 or FIG. 5 of SMPTE372:2011. One word-punctured signal is a 4:2:2/16-bit signal, and the other signal is a 0:2:2/16 without A ch.

Next, as illustrated in FIG. 7, the mapping controller 15-1 classifies the 4:2:2/16-bit signal into ch 1 (the first channel of 1.5 G-SDI) and ch 2 (the second channel of 1.5 G-SDI), and maps the signal on 2 ch 1.5 G-SDI.

Meanwhile, the example of the first mapping structure illustrated in FIG. 7 needs the following conditions.

(1) MSB (most significant bit) 2 bits (b14 and b15) of pixels enable a measuring instrument to observe first and second links of 1.5 G-SDI as video signals. Hence, b14 and b15 are multiplexed on b8 and b9 which are upper 2 bits of the first and second links of 1.5 G-SDI.
(2) In order to avoid forbidden codes of 1.5 G-SDI and, in addition, in order to enable a 16-bit signal to take a value of all0 to all1, b2 of first and second links of 1.5 G-SDI have inverse bits of b3.
(3) Data structures such as SAV/EAV, LN and CRCC are based on a data structure of effective sample of 1920 or 2048 defined according to SMPTE292-1.

The mapping controller 15-1 used as a first mapping controller maps an odd bit of a G signal including the same sample number as the Y channel, on the Y channel of the first HD-SDI, maps an odd bit of a B signal including the same sample number as the C_{B} channel, on the C_{B} channel, and maps an odd bit of a R signal including the same sample number as the C_{R}, on the C_{R} channel. Further, the mapping controller 15-1 multiplexes G14 and G15 of the G signal including the same sample number as the Y channel to be multiplexed, on upper 2 bits, multiplexes B14 and B15 of the B signal including the same sample number as the C_{B} channel to be multiplexed, on upper 2 bits of the C_{B} channel, and multiplexes R14 and R15 of the R signal including the same number as the C_{R} channel to be multiplexed, on the upper 2 bits of the C_{R} channel. Furthermore, the mapping controller 15-1 maps the even bit of the G signal including the same sample number, on the Y channel of the second HD-SDI, maps the even bit of the B signal including the same sample number, on the C_{B} channel and maps the even bit of the R signal including the same sample number, on the C_{R} channel. Still further, the mapping controller 15-1 multiplexes G14 and G15 of the G signal including the same sample number as the Y channel to be multiplexed, on the upper 2 bits of the Y channel, multiplexes B14 and B15 of the B signal including the same sample number as the C_{B} channel to be multiplexed, on upper 2 bits of the C_{B} channel, and multiplexes R14 and R15 of the R signal including the same sample number as the C_{R} channel to be multiplexed, on upper 2 bits of the C_{R} channel. Then, the mapping controller 15-1 multiplexes inverse bits obtained by inverting bits at predetermined positions for each channel of the Y channel, the C_{B} channel and the C_{R} channel of the first and second HD-SDI.

Meanwhile, the 4:2:2/16-bit signal includes the G signal of all samples and B and R signals of even samples. The 16 bits of these G, B and R signals are described as follows. For example, in case of the G signal, 16 bits are G0 (LSB: Least Significant Bit), G1, G2, G3, G4, G5, G6, G6, G7, G8, G9, G10, G11, G12, G13, G14 and G15 (MSB: Most Significant Bit). Similarly, in case of the B signal, 16 bits are B0, B1, B2, . . . and B15, and, in case of the R signal, 16 bits are R0, R1, R2, . . . and R15.

Further, the mapping controller 15-1 maps all samples which are the G signal of this 4:2:2/16-bit signal, on 10 bits included in Y ch of 2 ch of 1.5 G-SDI. Similarly, the mapping controller 15-1 maps the B signal of the even sample on 10 bits of the C_{B} channel, and maps the R signal of the even sample on 10 bits of the C_{R} channel.

As illustrated in FIG. 7A, the mapping controller 15-1 multiplexes G15, B15 and R15, and G14, B14 and R14 which are upper 2 bits of the G, B and R signals, on b9 and b8 of ch 1 and ch 2 of 1.5 G-SDI in the first ch of 1.5 G-SDI. The mapping controller 15-1 multiplexes odd bits of G0, B0 and R0 to G13, B13 and R13 of the G, B and R signals on upper to lower bits of 10 bits of 1.5 G-SDI in order from the upper bit of 16 bits in the first ch of 1.5 G-SDI.

As illustrated in FIG. 7B, the mapping controller 15-1 multiplexes even bits included in G0, B0 and R0 to G13. B13 and R13 of the G, B and R signals in the second ch of 1.5 G-SDI. This multiplexing is performed on upper bits to lower bits of 10 bits of 1.5 G-SDI in order from the upper bit of 16 bits. In this case, the 16 bit video signal takes all0 to all1 as a value. Meanwhile, to prevent forbidden codes from being produced in 1.5 G-SDI, values of b2 are both are inverse bits of b3 in the first and second channels of 1.5 G-SDI. By so doing, forbidden codes 000h to 003h and 3FCh to 3FFh of 1.5 G-SDI are prevented from being produced in the Y channel, the C_{B} channel and the C_{R} channel.

### Example of Second Mapping Structure

FIG. 8 illustrates an example of the second mapping structure which is referred to when the 30 P or 60I/0:2:2/16-bit signal is mapped on 1.5 G-SDI.

Meanwhile, the example of the second mapping structure illustrated in FIG. 8 needs the following conditions.

(1) A C_{B} sample is multiplexed with upper 9 bits of the B signal including the same sample number as 16 bits, and is transmitted.
(2) A C_{R} sample is multiplexed with upper 9 bits of the R signal including same sample number as 16 bits, and is transmitted.
(3) An odd sample of the Y channel is multiplexed to the enable a measuring instrument to observe the 1.5 G-SDI link as a video signal. For example, upper 2 bits (G15 and G14) of the G signal including the same sample number as 16 bits and lower 7 bits of the B signal of 16 bits are multiplexed and transmitted.
(4) An even sample of the Y channel is multiplexed to enable the measuring instrument to observe the 1.5 G-SDI link as a video signal. For example, upper 2 bits (G15 and G14) of the G signal including the same sample number as 16 bits and lower 7 bits of the R signal of 16 bits are multiplexed and transmitted.
(5) In order to avoid forbidden codes of 1.5 G-SDI and, in addition, in order to enable the 16-bit signal to take a value of all0 to all1 of a pixel, b2 of 1.5 G-SDI even and odd links have inverse bits of b3.
(6) Data structures such as SAV/EAV, LN and CRCC are based on a data structure of an effective pixel sample of 1920 or 2048 defined according to SMPTE292-1.

The mapping controller 15-2 used as a second mapping controller maps lower 7 bits of the B signal on even samples of the Y channel of the third HD-SDI. Further, the mapping controller 15-2 multiplexes G14 and G15 of the G signal including the same sample number (even sample) as the Y channel, on upper 2 bits of the even sample of the Y channel, maps lower 7 bits of the R signal on an odd sample of the Y channel in the third HD-SDI, and multiplexes G14 and G15 of the G signal including the same sample number (odd sample) as the Y channel, on the upper 2 bits of the odd sample of the Y channel. Further, the mapping controller 15-2 maps the upper 9 bits of the B signal including the same sample number, on the C_{B} channel, and maps upper 9 bits of the R signal including the same sample number, on the C_{R} channel. Then, the mapping controller 15-2 multiplexes inverse bits obtained by inversing bits at predetermined positions for each channel of the even and odd samples of the Y channel, the C_{B} channel and the C_{R} channel.

Meanwhile, the 0:2:2/16-bit signal includes the B and R signals of odd samples without the G signal. Hence, the mapping controller 15-2 multiplexes 16 bits which are the B and R signals of the odd sample and the upper 2 bits of the G signal, on 1 ch 1.5 G-SDI as illustrated in FIG. 8.

Further, the mapping controller 15-2 multiplexes the upper 2 bits (G15 and G14) of the G signal on b9 and b8 of Y ch of the even sample and the odd sample of 1.5 G-SDI. The mapping controller 15-2 multiplexes lower 7 bits of the B signal on b7 to b0 of the even sample Y ch in order of B1 and B0 which is the inverse order of B6, B5, B4, B3, B2 and B1. The mapping controller 15-2 multiplexes lower 7 bits of the R signal on b7 to b0 of the odd sample Y ch in order of R1 and R0 which is the inverse order of R6, R5, R4, R3, R2 and R1.

Further, the mapping controller 15-2 multiplexes upper 9 bits of the 16 bits which are the B signal and the R signal, on the C_{B} channel and the C_{R} channel as illustrated in the second mapping structure. This multiplexing order is B8, B7 . . . which is an inverse order of B15, B14, B13, B12, B11, B10, B9 and B8. Further, the bits are multiplexed on the C_{R} channel in order of R8, R7 and . . . which is an inverse order of R15, R14, R13, R12, R11, R10, R9 and R8.

In this case, the 16 bit video signal takes all0 to all1 as a value, and b2 is an inverse bit of b3 in the Y channel, the C_{B} channel and the C_{R} channel of 1.5 G-SDI, respectively to prevent forbidden codes from being produced in 1.5 G-SDI. By so doing, it is possible to prevent forbidden codes 000h to 003h and 3FCh to 3FFh of 1.5 G-SDI from being produced.

According to the above method, it is possible to map the 2 k/23.98 P-30 P or 47.95I-60I/4:4:4/16-bit signal on 3 ch 1.5 G-SDI, and transmit the bit signal.

In addition, when an ANC/audio signal has to be multiplexed, data is multiplexed in order from, for example, ch 1 of 1.5 G-SDI based on SMPTE291 or SMPTE299 which is the ANC/audio standard for 1.5 G-SDI.

### Internal Configuration Example of Signal Receiving Device

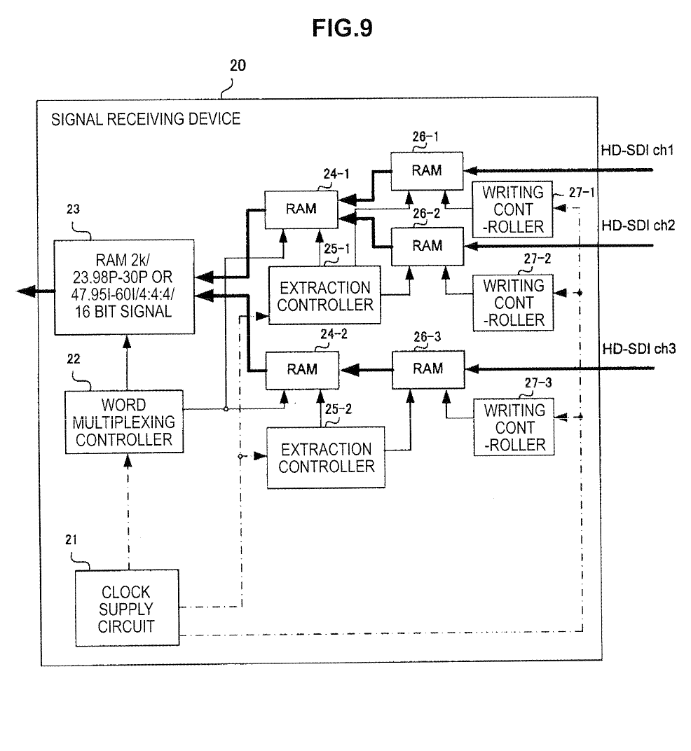

FIG. 9 illustrates an internal configuration example of the signal receiving device 20.

The CCU 2 has the signal receiving device 20 which plays back the 2 k/23.98 P-30 P or 47.95I-60I/4:4:4/16-bit signal from 3 ch HD-SDI input from the signal transmitting device 10 of the broadcasting camera 1. The signal receiving device 20 according to the first embodiment of the present disclosure realizes a signal transmitting method performed by internal blocks in cooperation by executing a program.

The signal receiving device 20 has a clock supply circuit 21 which supplies a clock to each unit, and a RAM 23 which temporarily stores the word-multiplexed 2 k/23.98 P-30 P or 47.95I-60I/4:4:4/16-bit signal.

Further, the signal receiving device 20 has a word multiplexing controller 22 which controls word multiplexing. Furthermore, the word multiplexing controller 22 has RAMs 24-1 and 24-2 which store 1 ch 2 k/23.98 P-30 P or 47.95I-60I/4:2:2/16-bit signal and a 1 ch 2 k/23.98 P-30 P or 47.95I-60I/0:2:2/16-bit signal.

Still further, the signal receiving device 20 has extraction controllers 25-1 and 25-2 which extract data based on the above first and second mapping structures. Moreover, the signal receiving device 20 has a writing controller 27-1 which writes in the RAM 26-1 the 2 k/23.98 P-30 P or 47.95I-60I/4:2:2/10-bit signal which is the first HD-SDI input from the signal transmitting device 10. Similarly, the signal is receiving device 20 has a writing controller 27-2 which writes in the RAM 26-2 the 2 k/23.98 P-30 P or 47.95I-60I/4:2:2/10-bit signal which is the second HD-SDI input from the signal transmitting device 10. Further, the signal receiving device 20 has a writing controller 27-3 which writes in the RAM 26-3 the 2 k/23.98 P-30 P or 47.95I-60I/4:2:2/10-bit signal which is the third HD-SDI input from the signal transmitting device 10.

Next, an operation example of the signal receiving device 20 will be described.

The clock supply circuit 21 supplies clocks used for reading or writing pixel samples from or in the word multiplexing controller 22, the extraction controllers 25-1 and 25-2 and the writing controllers 27-1 to 27-3, and each unit synchronizes according to this clock.

The writing controllers 27-1 to 27-3 write the first to third HD-SDI including the 3 ch 10-bit signals including 4:2:2 of r:g:b, in the RAMs 26-1 to 26-3.

The extraction controllers 25-1 and 25-2 read the first to third HD-SDI from the RAMs 26-1 to 26-3. In this case, the mapping controller 15-1 of the above signal transmitting device 10 performs inverse conversion of processing of performing mapping according to the first mapping structure (see FIG. 7). More specifically, the extraction controller 25-1 reads the 21 k/23.98 P-30 P or 47.95I-60I/4:2:2/10-bit signal per 1 ch from the RAMs 26-1 and 26-2. In this case, the extraction controller 25-1 extracts the 1 ch 16-bit signal including 4:2:2 of r:g:b and including the G signal of all samples and the B and R signals of even samples, from the first and second HD-SDI including 2 ch 10-bit signals according to the first mapping structure. Further, the extraction controller 25-1 writes the 1 ch 2 k/23.98 P-30 P or 47.95I-60I/4:2:2/16-bit signal in the RAM 24-1.

Meanwhile, processing of the extraction controller 25-1 will be described.

The extraction controller 25-1 used as a first extraction controller extracts an odd bit of the G signal including the same sample number as the Y channel, from the Y channel of the first HD-SDI, extracts an odd bit of the B signal including the same sample number as the C_{B} channel, from the C_{B} channel, and extracts an odd bit of the R signal including the same sample number as the C_{R} channel, from the C_{R} channel. Further, the extraction controller 25-1 extracts G14 and G15 of the G signal including the same sample number as the Y channel, from the upper 2 bits of the Y channel, extracts B14 and B15 of the B signal including the same sample number as the C_{B} channel, from the upper 2 bits of the C_{B} channel, and extracts R14 and R15 of the R signal including the same sample number as the C_{R} channel, from the upper 2 bits of the C_{R} channel. Furthermore, the extraction controller 25-1 extracts the even bit of the G signal including the same sample number as the Y channel, from the Y channel of the second HD-SDI, extracts the even bit of the B signal including the same sample number as the C_{B} channel, from the C_{B} channel, and extracts the even bit of the R signal including the same sample number as the C_{R} channel, from the C_{R} channel. Still further, the extraction controller 25-1 extracts G14 and G15 of the G signal including the same sample number as the Y channel, from the upper 2 bits of the Y channel, extracts B14 and B15 of the B signal including the same sample number as the C_{B} channel, from the upper 2 bits of the C_{B} channel, and extracts R14 and R15 of the R signal including the same sample number as the C_{R} channel, from the upper 2 bits of the C_{R} channel.

Meanwhile, the extraction controller 25-2 reads the 1 ch 2 k/23.98 P-30 P or 47.95I-60I/4:2:2/10-bit signal from the RAM 26-3. In this case, the mapping controller 15-2 of the above signal transmitting device 10 performs inverse conversion of processing of performing mapping according to the second mapping structure (see FIG. 8). More specifically, the extraction controller 25-2 extracts the 1 ch 16-bit signal, from the third HD-SDI including 4:2:2 of r:g:b and including the 1 ch 10-bit signal according to the second mapping structure. This 1 ch 16-bit signal includes 0:2:2 of r:g:b and includes the B and R signals of odd samples without the G signal. Further, the extraction controller 25-2 writes the 1 ch 2 k/23.98 P-30 P or 47.95I-60I/0:2:2/16-bit signal in the RAM 24-2.

Hereinafter, processing of the extraction controller 25-2 will be described.

The extraction controller 25-2 used as a second extraction controller extracts lower 7 bits of the B signal from the even sample of the Y channel in the third HD-SDI. Further, the extraction controller 25-2 extracts G14 and G15 from upper 2 bits of the G signal including the same sample number (even sample) as the Y channel, and extracts lower 7 bits of the R signal from the G signal including the same sample number (odd sample) as the Y channel in the third HD-SDI. Furthermore, the extraction controller 25-2 extracts G14 and G15 from the upper 2 bits of the odd sample of the Y channel, and extracts upper 9 bits of the B signal from the C_{B} channel, and extracts the upper 9 bits of the R signal from the C_{R} channel.

The word multiplexing controller 22 word-multiplexes 2 ch 16-bit signals read from the RAMs 24-1 and 24-2, and writes the 1 ch 2 k/23.98 P-30 P or 47.95I-60I/4:4:4/16-bit signal in the RAM 23. More specifically, the word multiplexing controller 22 multiplexes per word the 1 ch 16-bit signal including 4:2:2 of r:g:b and the 1 ch 16-bit signal including 0:2:2 of r:g:b. By this means, the 1 ch 16-bit signal including 4:4:4 of r:g:b and including the G, R and B signals of all samples is generated. Further, this signal is played back adequately from the RAM 23.

In addition, although an example has been described with FIG. 9 where word multiplexing and extraction control are performed at two stages using two types of RAMs, a 2 k/23.98 P-30 P or 47.95I-60I/4:4:4/16-bit signal may be played back using one RAM.

The transmitting system according to the above-described first embodiment performs word puncturing and mapping of a 2 k/23.98 P-30 P or 47.95I-60I/4:4:4/16-bit signal. By this means, it is possible to generate and output 3 ch HD-SDI signals. Consequently, the broadcasting camera 1 can convert the 2 k/23.98 P-30 P or 47.95I-60I/4:4:4/16-bit signal into serial/digital data with the bit rate of 1.5 Gbps, and transmit the serial/digital data to the CCU 2.

Meanwhile, the CCU 2 can play back the 2 k/23.98 P-30 P or 47.95I-60I/4:4:4/16-bit signal from serial/digital data with the bit rate of 1.5 Gbps. That is, it is possible to transmit the 2 k/23.98 P-30 P or 47.95I-60I/4:4:4/16-bit signal through multiple channels of a serial interface of 1.5 Gbps which has been used in related art. Consequently, it is possible to effectively take an advantage of existing equipment in order to transmit signals.

### 2. Second Embodiment

### An Example Where a 2 k/47.95 P-60 P/4:4:4/16-bit Signal is Mapped on 1.5 G-SDI 6 ch and is Transmitted

### Internal Configuration Example of Signal Transmitting Device

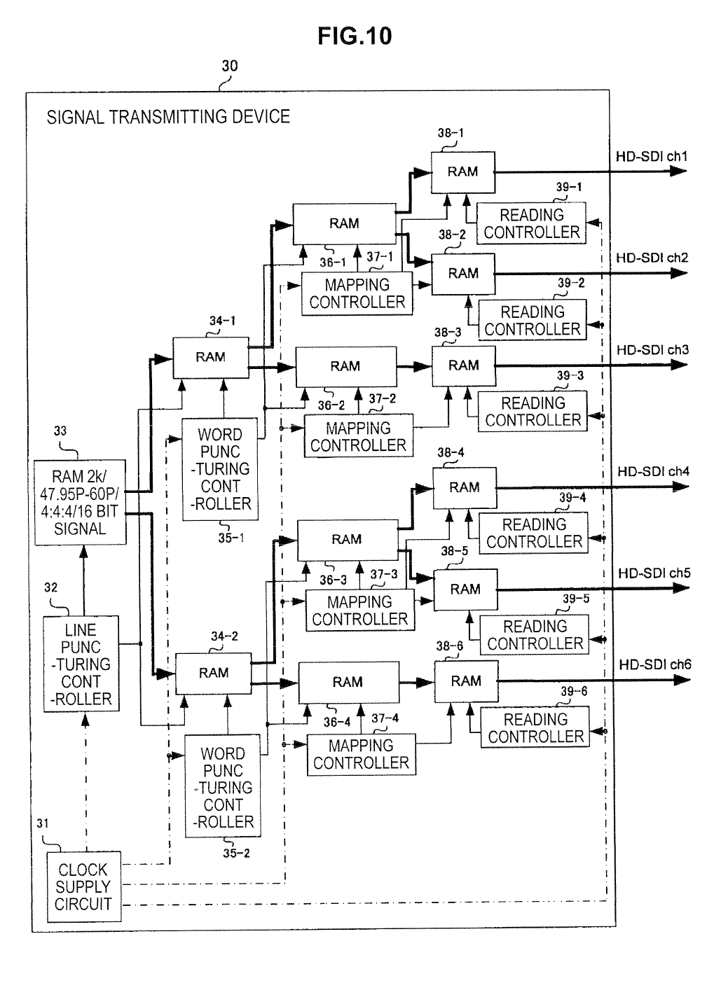

FIG. 10 illustrates an internal configuration example of a signal transmitting device 30.

The broadcasting camera 1 according to a second embodiment of the present disclosure has a signal transmitting device 30 which outputs a 2 k/47.95 P-60 P/4:4:4/16-bit signal to a signal receiving device 40 of a CCU 2 using 3 ch HD-SDI. In the following description, 47.95 P,48 P,50 P,59.94 P,60 P is abbreviated as “47.95 P-60 P” in some cases.

The signal transmitting device 30 has a clock supply circuit 31 which supplies a clock to each unit, and a RAM 33 which stores the 2 k/47.95 P-60 P/4:4:4/16-bit signal. Further, the signal transmitting device 30 has two sets of word puncturing controllers 12, mapping controllers 15-1 and 15-2 and reading controllers 17-1 to 17-3 of the signal transmitting device 10 according to the first embodiment. Hence, the signal transmitting device 30 additionally has two sets of RAMs which store HD-SDI mapped by each control block.

That is, the signal transmitting device 30 has a line puncturing controller 32 which alternately punctures one line by one line a 1 ch 16-bit signal read from the RAM 33 and including 4:4:4 of r:g:b, and writes a video signal which are 2 channel interlace signals (2 k/47.95I-60I/4:4:4/16-bit signals), in RAMs 34-1 and 34-2. Further, the signal transmitting device 30 has the RAMs 34-1 and 34-2 in which data line-punctured by the line puncturing controller 32 is written. Furthermore, the signal transmitting device 30 has word puncturing controllers 35-1 and 35-2 which control word puncturing, and RAMs 36-1 to 36-4 in which data word-punctured by the word puncturing controllers 35-1 and 35-2 is written.

Still further, the signal transmitting device 30 has a mapping controller 37-1 which maps a 2 k/47.95I-60I/4:2:2/16-bit signal read from the RAM 36-1, according to a first mapping structure (see FIG. 7). Moreover, the signal transmitting device 30 has RAMs 38-1 and 38-2 which store 2 ch 10-bit signals mapped by the mapping controller 37-1.

Further, the signal transmitting device 30 has a mapping controller 37-2 which maps a 2 k/47.95I-60I/0:2:2/16-bit signal read from the RAM 36-2, according to a second mapping structure. Furthermore, the signal transmitting device 30 has a RAM 38-3 which stores a 1 ch 10-bit signal mapped by the mapping controller 37-2.

Still further, the signal transmitting device 30 has a mapping controller 37-3 which maps the 2 k/47.95I-60I/4:2:2/16 read from the RAM 36-3, according to the first mapping structure. Moreover, the mapping controller 37-1 has RAMs 38-4 and 38-5 which store 2 ch 10-bit signals mapped by the mapping controller 37-1.

Further, the signal transmitting device 30 has a mapping controller 37-3 which maps the 2 k/47.95I-60I/0:2:2/16 read from the RAM 36-4, according to the second mapping structure. Furthermore, the signal transmitting device 30 has a RAM 38-6 which stores a 1 ch 10-bit signal mapped by the mapping controller 37-4.

Still further, reading controllers 39-1 to 39-6 output two sets of first to third HD-SDI read from the RAMs 38-1 to 38-6. Hence, the signal transmitting device 30 has the reading controllers 39-1 to 39-6 which output pixel samples read from the RAMs 38-1 to 38-6 HD-SDI ch 1 to ch 6 of six channels.

Next, an operation example of each unit will be described.

The clock supply circuit 31 supplies clocks used for reading or writing pixel samples to or in the line puncturing controller 32, the word puncturing controllers 35-1 and 35-2, the mapping controllers 37-1 to 37-4 and the reading controllers 39-1 to 39-6. Each unit operates in synchronization with this supplied clock.

The 2 k/47.95 P-60 P/4:4:4/16-bit signal input from the image sensor which is not illustrated is stored in the RAM 33.

The line puncturing controller 32 alternately reads the 2 k/47.95 P-60 P/4:4:4/16-bit signal stored in the RAM 33 one line by one line, and stores the signal in the RAMs 34-1 and 34-2. In this case, in the RAM 34-1, the 1 ch 2 k/47.95I-60I/4:4:4/16-bit signal is written. Meanwhile, in the RAM 34-2, 1 ch 2 k/47.95 P-60 P/4:4:4/16-bit signal is written.

The word puncturing controllers 35-1 and 35-2 perform word puncturing according to the same scheme as FIGS. 4, 6, 7, 8 and 9 of SMPTE372 using pixel samples read from the RAM 34-1 and 34-2. In this case, the 2 k/47.95I-60I/4:2:2/16-bit signal is written in the RAM 36-1, and the 2 k/47.95I-60I/0:2:2/16-bit signal is written in the RAM 36-2. Similarly, the 2 k/47.95I-60I/4:2:2/16-bit signal is written in the RAM 36-3, and the 2 k/47.95I-60I/0:2:2/16-bit signal is written in the RAM 36-4.

The mapping controller 37-1 maps the 2 k/47.95I-60I/4:2:2/16 read from the RAM 36-1, on 2 ch 10-bit signals again, and writes the bit signal in the RAMs 38-1 and 38-2. In this case, in the RAM 38-1, the 1 ch 2 k/47.95I-60I/4:2:2/10-bit signal extracted from odd bits is written. Meanwhile, in the RAM 38-2, 1 ch 2 k/47.95I-60I/4:2:2/10-bit signal extracted from even bits is written.

The mapping controller 37-2 maps the 2 k/47.95I-60I/0:2:2/16-bit signal read from the RAM 36-2, on the 1 ch 2 k/47.95I-60I/4:2:2/10-bit signal again, and writes the bit signal in the RAM 38-3.

The mapping controller 37-3 maps the 2 k/47.95I-60I/4:2:2/16-bit signal read from the RAM 36-3, on 2 ch 10-bit signals again, and writes the bit signal in the RAMs 38-4 and 38-5. In this case, in the RAM 38-4, the 1 ch 2 k/47.95I-60I/4:2:2/10 extracted from odd bits is written. Meanwhile, in the RAM 38-5, the 1 ch 2 k/47.95I-60I/4:2:2/10-bit signal extracted from even bits is written.

The mapping controller 37-4 maps the 2 k/47.95I-60I/0:2:2/16-bit signal read from the RAM 36-4, on the 1 ch 2 k/47.95I-60I/4:2:2/10 again, and writes the bit signal in the RAM 38-6.

Further, the reading controllers 39-1 to 39-6 read 6 ch 2 k/47.95I-60I/4:2:2/10-bit signals from the RAMs 38-1 to 38-6 according to a reference signal supplied from the clock supply circuit 31. Then, the reading controllers 39-1 to 39-6 output the signals as 6 ch HD-SDI ch 1 to ch 6.

In addition, an example has been described with the present example where line puncturing, word puncturing and mapping control are performed at three stages using four types of memories (RAM33, RAMs 34-1 and 34-2, RAMs 36-1 to 36-4, and RAMs 38-1 to 38-6). However, the line-punctured and word-punctured data may be mapped again using one memory, and output as 6 ch HD-SDI.

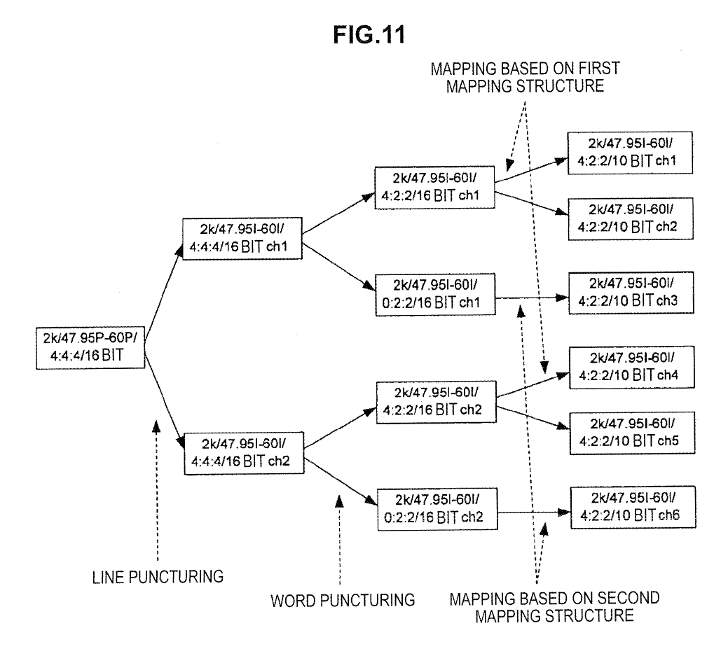

FIG. 11 illustrates a schematic example of processing of performing line puncturing, word puncturing and mapping control of the 2 k/47.95 P-60 P/4:4:4/16-bit signal.

First, the 2 k/47.95 P-60 P/4:4:4/16-bit signal is line-punctured based on FIG. 2 of SMPTE372:2011, and is converted into 2 ch 2 k/47.95I-60I/4:4:4/16-bit signals.

Next, a 4:4:4/16-bit signal is word-punctured based on FIG. 3 or 5 of SMPTE372:2011. One signal is a 4:2:2/16-bit signal, and the other signal is a 0:2:2/16-bit signal without A ch. By multiplexing this 4:2:2/16-bit signal on ⅕ G-SDI according to the first and second mapping structures (see FIGS. 7 and 8), it is possible to transmit 6 ch ⅕ G-SDI in total.

In addition, when it is necessary to multiplex an ANC/audio signal, data is multiplexed in order from, for example, ch 1 of 1.5 G-SDI based on SMPTE291 or SMPTE299 which is the ANC/audio standard for 1.5 G-SDI.

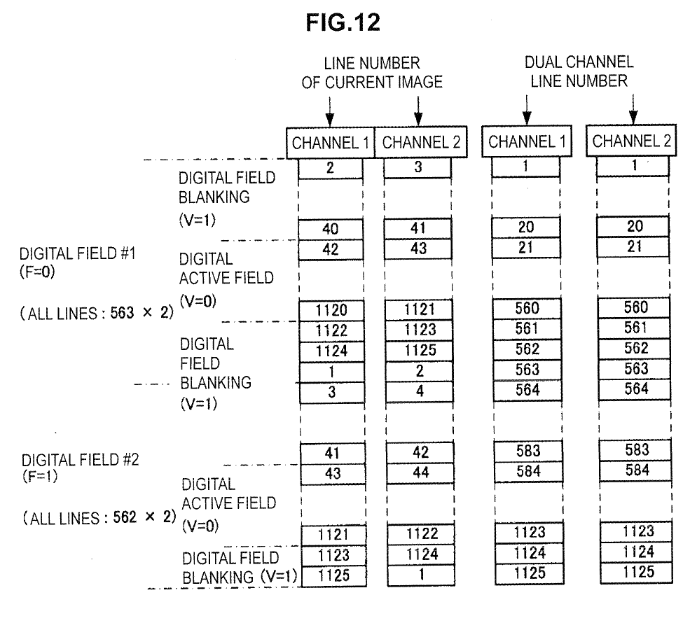

FIG. 12 illustrates an example of line puncturing.

Meanwhile, line puncturing will be described using an example of a line number and a package of a dual link interface.

First, the line puncturing controller 32 line-punctures a 2 k/47.95 P-60 P/4:4:4/16-bit signal to channels 1 and 2. By this means, the line-punctured signals are converted into 2 ch 2 k/47.95I-60I/4:4:4/16-bit signals.

Then, as described above, the mapping controllers 37-1 to 37-4 map data based on the first and second mapping structures (see FIGS. 7 and 8), and the reading controllers 39-1 to 39-6 output 6 ch HD-SDI.

### Internal Configuration Example of Signal Receiving Device

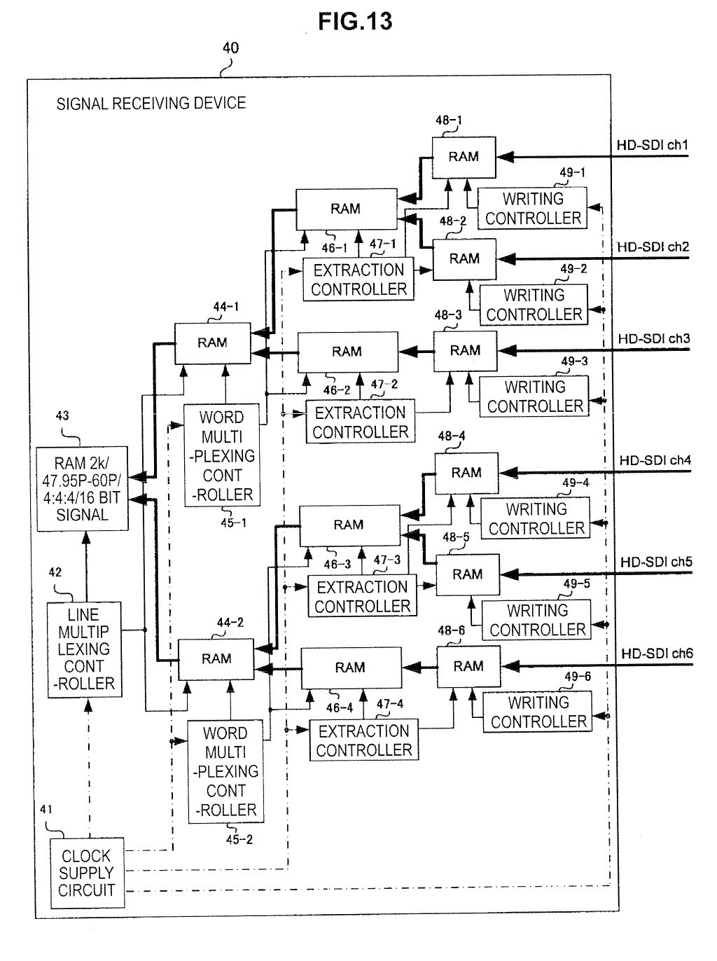

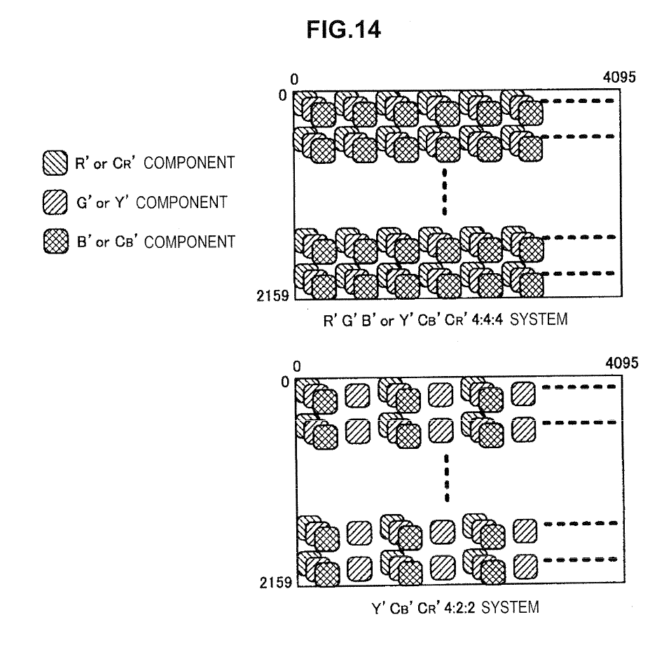

FIG. 13 illustrates an internal configuration example of the signal receiving device 40.

The CCU 2 has the signal receiving device 40 which plays back the 2 k/47.95 P-60 P/4:4:4/16-bit signal from the 6 ch HD-SDI input from the signal transmitting device 30 of the broadcasting camera 1.

The signal receiving device 40 has a clock supply circuit 41 which supplies a clock to each unit, and a RAM 43 which stores a video signal of the 2 k/47.95 P-60 P/4:4:4/16 bit. Further, the signal receiving device 40 has two sets of writing controllers 27-1 to 27-3, extraction controllers 25-1 and 25-2 and a word multiplexing controller 22 of the signal receiving device 20 according to the above first embodiment. Hence, the signal receiving device 40 additionally has two sets of RAMs which store HD-SDI mapped by each control block.

That is, the signal receiving device 40 has RAMs 48-2 to 48-6 which store six HD-SDI ch 1 to ch 6 input from the signal transmitting device 30. The six HD-SDI ch 1 to ch 6 include 6 ch 2 k/47.95I-60I/4:2:2/10-bit signals. Further, the writing controllers 49-1 to 49-6 write the two sets of the first to third HD-SDI input from the signal transmitting device 30, in the RAMs 48-1 to 48-6. Hence, the writing controllers 49-1 to 49-6 perform control of writing the input six HD-SDI ch 1 to ch 6 in the RAMs 48-1 to 48-6 according to a clock supplied from the clock supply circuit 41.

Further, the signal receiving device 40 has extraction controllers 47-1 to 47-4 which extract data based on the above-described first and second mapping structures (see FIGS. 7 and 8). Furthermore, the signal receiving device 40 has a writing controller 49-1 which writes in the RAM 48-1 the 2 k/47.95I-60I/4:2:2/10-bit signal which is the first HD-SDI input from the signal transmitting device 30. Similarly, the signal receiving device 40 has a writing controller 49-2 which writes in the RAM 48-2 the 2 k/47.95I-60I/4:2:2/10-bit signal which is the second HD-SDI input from the signal transmitting device 30. Further, the signal receiving device 40 has a writing controller 49-3 which writes in the RAM 48-3 the 2 k/47.95I-60I/4:2:2/10-bit signal which is the third HD-SDI input from the signal transmitting device 30.

Furthermore, the signal receiving device 40 has a writing controller 49-4 which writes in the RAM 48-4 the 2 k/47.95I-60I/4:2:2/10-bit signal which is the fourth HD-SDI input from the signal transmitting device 30. Similarly, the signal receiving device 40 has a writing controller 49-5 which writes in the RAM 48-5 the 2 k/47.95I-60I/4:2:2/10-bit signal which is the fifth HD-SDI input from the signal transmitting device 30. Further, the signal receiving device 40 has a writing controller 49-6 which writes in the RAM 48-6 the 2 k/47.95I-60I/4:2:2/10 which is the sixth HD-SDI input from the signal transmitting device 30.

Furthermore, the signal receiving device 40 has RAMs 44-1 and 44-2 in which data temporarily multiplexed by the word multiplexing controllers 45-1 and 45-2 which controls word multiplexing and the word multiplexing controllers 45-1 and 45-2 are written. The word multiplexing controllers 45-1 and 45-2 read data in word units of inverse conversion of FIGS. 4, 6, 7, 8 and 9 of SMPTE372 by controlling predetermined timings. This reading timing is determined per (RAMs 46-1 and 46-2) and (RAMs 46-3 and 46-4).

Further, the signal receiving device 40 has a line multiplexing controller 42 which alternately multiplexes pixel samples multiplexed by the word multiplexing controllers 45-1 and 45-2 one line by one line. More specifically, the line multiplexing controller 42 reads pixel samples from the RAMs 44-1 and 44-2, alternately multiplexes the pixel samples one line by one line, and writes the pixel samples in the RAM 43 in which the multiplexed data is written. By this means, the 2 k/47.95 P-60 P/4:4:4/16-bit signal is stored in the RAM 43, and this signal is adequately played back.

Next, an operation example of the signal receiving device 40 will be described.

The clock supply circuit 41 supplies a clock used for reading or writing pixel samples to or in the line multiplexing controller 42, the word multiplexing controllers 45-1 and 45-2, the extraction controllers 47-1 to 47-4 and the writing controllers 49-1 to 49-6, and each unit synchronizes according to this clock.

The extraction controller 47-1 reads the 2 k/47.95I-60I/4:2:2/10-bit signal per 1 ch from the RAMs 48-1 and 48-2. In this case, the mapping controller 37-1 of the above signal transmitting device 30 performs inverse conversion of processing of performing mapping according to the first mapping structure (see FIG. 7). Further, the extraction controller 47-1 writes the 1 ch 2 k/47.95I-60I/4:2:2/16-bit signal in the RAM 46-1.

The extraction controller 47-2 reads the 1 ch 2 k/47.95I-60I/4:2:2/10-bit signal from the RAM 48-3. In this case, the mapping controller 37-2 of the above signal transmitting device 10 performs inverse conversion of processing of performing mapping according to the second mapping structure (see FIG. 8). Further, the extraction controller 47-2 writes the 1 ch 2 k/47.95I-60I/0:2:2/16-bit signal in the RAM 46-2.

Similarly, the extraction controller 47-3 reads the 2 k/47.95I-60I/4:2:2/10-bit signal per 1 ch from the RAMs 48-4 and 48-5. In this case, the mapping controller 37-3 of the above signal transmitting device 30 performs inverse conversion of processing of performing mapping according to the first mapping structure (see FIG. 7). Further, the extraction controller 47-3 writes the 1 ch 2 k/47.95I-60I/4:2:2/16-bit signal in the RAM 46-3.

The extraction controller 47-4 reads the 1 ch 2 k/47.95I-60I/4:2:2/10-bit signal from the RAM 48-6. In this case, the mapping controller 37-4 of the above signal transmitting device 10 performs inverse conversion of processing of performing mapping according to the second mapping structure (see FIG. 8). Further, the extraction controller 47-4 writes the 1 ch 2 k/47.95I-60I/0:2:2/16-bit signal in the RAM 46-4.

The word multiplexing controller 45-1 word-multiplexes the 2 ch 2 k/47.95I-60I/4:2:2/16-bit signal and 2 k/47.95I-60I/0:2:2/16-bit signal read from the RAMs 46-1 and 46-2. The 1 ch 2 k/47.95I-60I/4:4:4/16-bit signal obtained as a result is written in the RAM 44-1.

Similarly, the word multiplexing controller 45-2 word-multiplexes the 2 ch 2 k/47.95I-60I/4:2:2/16-bit signal and 2 k/47.95I-60I/0:2:2/16-bit signal read from the RAMs 46-3 and 46-4. The 1 ch 2 k/47.95I-60I/4:4:4/16-bit signal obtained as a result is written in the RAM 44-2.

The line multiplexing controller 42 alternately line-multiplexes one line by one line the 2 k/47.95I-60I/4:4:4/16-bit signal read from the RAM 44-1 and the 2 k/47.95I-60I/4:4:4/16-bit signal read from the RAM 44-2. Further, the 1 ch 2 k/47.95 P-60 P/4:4:4/16-bit signal obtained by line multiplexing is written in the RAM 43. Furthermore, this signal is adequately played back from the RAM 43.

In addition, although an example has been described with FIG. 13 where extraction control, word multiplexing and line multiplexing are performed at three stages using three types of RAMs, 2 k/47.95 P-60 P/4:4:4/16 bit/4:4:4/10 bit and 12-bit signals may be generated using one RAM.

According to the above-described second embodiment, the signal transmitting device 30 can transmit 6 channel HD-SDI by performing line puncturing, word puncturing and mapping control of pixel samples of the 2 k/47.95 P-60 P/4:4:4/16-bit signal. Consequently, the broadcasting camera 1 can convert the 2 k/47.95 P-60 P/4:4:4/16-bit signal into serial/digital data with a bit rate of 1.5 Gbps, and transmit the serial/digital data to the CCU 2.

Meanwhile, the CCU 2 can play back the 2 k/47.95 P-60 P/4:4:4/16-bit signal from the serial/digital data with the bit rate of 1.5 Gbps. That is, 4 k×2 k signals can be transmitted through multiple channels of the serial interface of 1.5 Gbps which has been used in related art. Consequently, it is possible to effectively take an advantage of existing equipment in order to transmit signals.

The signal transmitting device and the signal receiving device according to the above first and second embodiments can map a 1920×1080 or 2048×1080/23.98 P-60 P/4:4:4/16-bit signal on 3 ch or 6 ch 1.5 G-SDI, and transmit the bit signal. Further, when a 1.5 G-SDI 3 ch or 6 ch signal is transmitted through one optical fiber, it is possible to use a CWDM/DWDM wavelength multiplexing technique.

Furthermore, all items of HD-SDI output through 3 ch or 6 ch can be observed as a video image or a waveform by a user using, for example, a waveform monitor. Consequently, that an actual device can be developed while checking video images is very useful.

Further, when forbidden codes based on SMPTE274 are provided, 0000h to 00FFh and FF00h to FFFFh signals of 16-bit signals are forbidden codes, and up to 512 codes may not be used, and therefore these are factors which significantly restrict representation of video images. However, the above present scheme does not have to be provided with forbidden codes, and can transmit all0 to all1 as video signals, and therefore is very useful. Further, the present scheme is useful for use in editing RAW data (so-called raw data).

Further, a video image signal is transmitted based on SMPTE S292-1, and SAV/EAV, LN and CRCC are based on SMPTE S274 and S292-1. Furthermore, when ANC/audio data is multiplexed, 1 ch to 6 ch of 6 ch 1.5 G-SDI can be multiplexed in order based on SMPTE S291 and S299-1. That is, it is possible to multiplex data such as ANC/audio based on the current HD related standard without providing a new rule.

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2011-190549 filed in the Japan Patent Office on Sep. 1, 2011, the entire content of which is hereby incorporated by reference.

What is claimed is:

1. A signal transmitting device comprising:
a word puncturing controller configured to, when a video signal output from an image sensor is defined according to m×n (where m and n refer to m samples×n lines)/a−b (where a and b refer to frame rates)/r:g:b (where r, g and b refer to signal ratios in case of a predetermined signal transmission scheme)/16-bit signal, and each bit of a G signal of all samples included in a 1 ch 16-bit signal is G0, G1, . . . and G15, each bit of a B signal is B0, B1, . . . and B15 and each bit of a R signal is R0, R1, . . . and R15, puncture per word the 1 ch 16-bit signal including 4:4:4 of r:g:b and including the G, B and R signals of all samples, and map a 1 ch 16 bit-signal including 4:2:2 of r:g:b and including a G signal of all samples and B and R signals of even samples, and a 1 ch 16-bit signal including 0:2:2 of r:g:b and including B and R signals of odd samples without a G signal;
a mapping controller configured to map the 1 ch 16-bit signal punctured per word and including 4:2:2 of r:g:b, on first and second HD-SDI including 2 ch 10-bit signals including 4:2:2 of r:g:b according to a first mapping structure, and map a 1 ch 16-bit signal punctured per word and including 0:2:2 of r:g:b, on third HD-SDI including a 1 ch 10-bit signal including 4:2:2 of r:g:b according to a second mapping structure; and
a reading controller configured to output the first to third HD-SDI.

2. The signal transmitting device according to claim 1, wherein the mapping controller comprises:
a first mapping controller configured to map an odd bit of the G signal including a sample number identical to a Y channel, on the Y channel of the first HD-SDI, map an odd bit of the B signal including a sample number identical to a C_{B} channel, on the C_{B} channel, map an odd bit of the R signal including a sample number identical to a C_{R} channel, on the C_{R} channel, multiplex G14 and G15 of the G signal including the sample number identical to the Y channel, on upper 2 bits of the Y channel, multiplex B14 and B15 of the B signal including the sample number identical to a C_{B} channel, on upper 2 bits of the C_{B} channel, multiplex R14 and R15 of the R signal including the sample number identical to a C_{R} channel, on upper 2 bits of the C_{R} channel, map the even bit of the G signal including the sample number identical to the Y channel, on the Y channel of the second HD-SDI, map the even bit of the B signal including the sample number identical to the C_{B}, on the C_{B} channel, map the even bit of the R signal including the sample number identical to the C_{R} channel, on the C_{R} channel, multiplex the G14 and G15 of the G signal including the sample number identical to the Y channel, on upper 2 bits of the Y channel, multiplex the B14 and B15 of the B signal including the sample number identical to the C_{B} channel, on the upper 2 bits of the C_{B} channel, multiplex the R14 and R15 of the R signal including the sample number identical to the C_{R} channel, on upper 2 bits of the C_{R} channel, and multiplex an inverse bit obtained by inverting a bit at a predetermined position, on each channel of the Y channel, the C_{B} channel and the C_{R} channel of the first and second HD-SDI; and
a second mapping controller configured to map lower 7 bits of the B signal on an even sample of the Y channel of the third HD-SDI, multiplex the G14 and G15 of the G signal including the sample number (the even sample) identical to the Y channel, on upper 2 bits of the even sample of the Y channel, map lower 7 bits of the R signal on an odd sample of the Y channel of the third HD-SDI, multiplex the G14 and G15 of the G signal including the sample number (odd sample) identical to the Y channel, on upper 2 bits of the odd sample of the Y channel, map upper 9 bits of the B signal including the sample number identical to the C_{B} channel, on the C_{B} channel, and map upper 9 bits of the R signal including the sample number identical to the C_{R} channel, and multiplex the inverse bit obtained by inverting the bit at the predetermined position, on each channel of the even sample and the odd sample of the Y channel, the C_{B} channel and the C_{R} channel.

3. The signal transmitting device according to claim 2, wherein the 1 ch 16-bit signal including 4:4:4 of r:g:b includes m×n of 1920 samples×1080 lines or 2048 samples×1080 lines, and a−b of 23.98 P-30 P or 47.95I-60I.

4. The signal transmitting device according to claim 2, comprising, when the 1 ch 16-bit signal including 4:4:4 of r:g:b includes m×n of 1920 samples×1080 lines or 2048 samples×1080 lines, and a−b of 47.95 P-60 P:
two sets of the word puncturing controllers;
two sets of the mapping controllers;
two sets of the reading controllers; and
a line puncturing controller configured to output a video signal obtained by alternately puncturing one line by one line the 1 ch 16-bit signal including 4:4:4 of r:g:b line as a 2 channel interlace signal, to the two sets of the word puncturing controllers,
wherein the two sets of the reading controllers output two sets of the first to third HD-SDI.

5. A signal transmitting method comprising:
when a video signal output from an image sensor is defined according to m×n (where m and n refer to m samples×n lines)/a−b (where a and b refer to frame rates)/r:g:b (where r, g and b refer to signal ratios in case of a predetermined signal transmission scheme)/16-bit signal, and each bit of a G signal of all samples included in a 1 ch 16-bit signal is G0, G1, . . . and G15, each bit of a B signal is B0, B1, . . . and B15 and each bit of a R signal is R0, R1, . . . and R15, puncturing per word the 1 ch 16-bit signal including 4:4:4 of r:g:b and including the G, B and R signals of all samples, and mapping a 1 ch 16-bit signal including 4:2:2 of r:g:b and including a G signal of all samples and B and R signals of even samples, and a 1 ch 16-bit signal including 0:2:2 of r:g:b and including B and R signals of odd samples without a G signal;
mapping the 1 ch 16-bit signal punctured per word and including 4:2:2 of r:g:b on first and second HD-SDI including 2 ch 10-bit signals including 4:2:2 of r:g:b according to a first mapping structure, and mapping a 1 ch 16-bit signal punctured per word and including 0:2:2 of r:g:b on third HD-SDI including a 1 ch 10-bit signal including 4:2:2 of r:g:b according to a second mapping structure; and
outputting the first to third HD-SDI.

6. A signal receiving device comprising:
a writing controller configured to, when a video signal output from an image sensor is defined according to m×n (where m and n refer to m samples×n lines)/a−b (where a and b refer to frame rates)/r:g:b (where r, g and b refer to signal ratios in case of a predetermined signal transmission scheme)/16-bit signal, and each bit of a G signal of all samples included in a 1 ch 16-bit signal is G0, G1, . . . and G15, each bit of a B signal is B0, B1, . . . and B15 and each bit of a R signal is R0, R1, . . . and R15, write first to third HD-SDI including 3 ch 10-bit signals including 4:2:2 of r:g:b, in a memory;
an extraction controller configured to extract the 1 ch 16-bit signal including 4:2:2 of r:g:b and including a G signal of all samples and B and R signals of even samples according to a first mapping structure, from the first and second HD-SDI including 2 ch 10-bit signals read from the memory, and extract a 1 ch 16-bit signal including 0:2:2 of r:g:b and including B and R signals of odd samples without a G signal according to a second mapping structure, from third HD-SDI including a 1 ch 10-bit signal including 4:2:2 of r:g:b; and
a word multiplexing controller configured to generate the 1 ch 16-bit signal including 4:4:4 of r:g:b and including G, B and R signals of all samples by multiplexing per word the 1 ch 16-bit signal including 4:2:2 of r:g:b and the 1 ch 16-bit signal including 0:2:2 of r:g:b.

7. The signal receiving device according to claim 6, wherein the extraction controller comprises:
a first extraction controller configured to extract an odd bit of the G signal including a sample number identical to a Y channel, from the Y channel of the first HD-SDI, extract an odd bit of the B signal including a sample number identical to a C_{B} channel, from the C_{B} channel, extract an odd bit of the R signal including a sample number identical to a C_{R} channel, from the C_{R} channel, extract the G14 and G15 of the G signal including the sample number identical to the Y channel, from upper 2 bits of the Y channel, extract the B14 and B15 of the B signal including the sample number identical to the C_{B} channel, from the upper 2 bits of the C_{B} channel, extract the R14 and R15 of the R signal including the sample number identical to the C_{R} channel, from upper 2 bits of the C_{R} channel, extract an even bit of the G signal including the sample number identical to the Y channel, from the Y channel of the second HD-SDI, extract even bits of the B signal including the sample number identical to the C_{B} channel, from the C_{B} channel, extract even bits of the R signal including the sample number identical to the C_{R} channel, from the C_{R} channel, extract the G14 and G15 of the G signal including the sample number identical to the Y channel, from upper 2 bits of the Y channel, extract the B14 and B15 of the B signal including the sample number identical to the C_{B} channel, from the upper 2 bits of the C_{B} channel, and extract the R14 and R15 of the R signal including the sample number identical to the C_{R} channel, from upper 2 bits of the C_{R} channel; and
a second extraction controller configured to extract lower 7 bits of the B signal on an even sample of the Y channel of the third HD-SDI, extract the G14 and G15 from upper 2 bits of the G signal including the sample number (the even sample) identical to the Y channel, extract lower 7 bits of the R signal from an odd sample of the Y channel of the third HD-SDI, extract the G14 and G15, from upper 2 bits of the G signal including the sample number (odd sample) identical to the Y channel, extract upper 9 bits of the B signal from the C_{B} channel, and extract upper 9 bits of the R signal from the C_{R} channel.

8. The signal receiving device according to claim 7, wherein the 1 ch 16-bit signal including 4:4:4 of r:g:b includes m×n of 1920 samples×1080 lines or 2048 samples×1080 lines, and a−b of 23.98 P-30 P or 47.95I-60I.

9. The signal receiving device according to claim 7, comprising, when the 1 ch 16-bit signal including 4:4:4 of r:g:b includes m×n of 1920 samples×1080 lines or 2048 samples×1080 lines, and a−b of 47.95 P-60 P:
two sets of the writing controllers;
two sets of the extraction controllers;
two sets of the word multiplexing controllers; and
a line multiplexing controller configured to provide the 1 ch 16-bit signal including 4:4:4 of r:g:b obtained by alternately multiplexing one line by one line an interlace signal which is word-multiplexed by the word multiplexing controller and which is the 2 ch 16-bit signals including 4:4:4 of r:g:b,
wherein the two sets of the reading controllers write two sets of the first to third HD-SDI to be input, in the memory.

10. A signal receiving method comprising:
when a video signal output from an image sensor is defined according to m×n (where m and n refer to m samples×n lines)/a−b (where a and b refer to frame rates)/r:g:b (where r, g and b refer to signal ratios in case of a predetermined signal transmission scheme)/16-bit signal, and each bit of a G signal of all samples included in a 1 ch 16-bit signal is G0, G1, . . . and G15, each bit of a B signal is B0, B1, . . . and B15 and each bit of a R signal is R0, R1, . . . and R15, writing first to third HD-SDI including 3 ch 10-bit signals including 4:2:2 of r:g:b, in a memory;
extracting the 1 ch 16-bit signal including 4:2:2 of r:g:b and including a G signal of all samples and B and R signals of even samples, from the first and second HD-SDI including 2 ch 10-bit signals read from the memory according to a first mapping structure, and extracting a 1 ch 16-bit signal including 0:2:2 of r:g:b and including B and R signals of odd samples without a G signal, from third HD-SDI including a 1 ch 10-bit signal including 4:2:2 of r:g:b according to a second mapping structure; and
generating the 1 ch 16-bit signal including 4:4:4 of r:g:b and including G, B and R signals of all samples by multiplexing per word the 1 ch 16-bit signal including 4:2:2 of r:g:b and the 1 ch 16-bit signal including 0:2:2 of r:g:b.

11. A signal transmitting system comprising:
a signal transmitting device including:
a word puncturing controller configured to, when a video signal output from an image sensor is defined according to m×n (where m and n refer to m samples×n lines)/a−b (where a and b refer to frame rates)/r:g:b (where r, g and b refer to signal ratios in case of a predetermined signal transmission scheme)/16-bit signal, and each bit of a G signal of all samples included in a 1 ch 16-bit signal is G0, G1, . . . and G15, each bit of a B signal is B0, B1, . . . and B15 and each bit of a R signal is R0, R1, . . . and R15, puncture per word the 1 ch 16-bit signal including 4:4:4 of r:g:b and including the G, B and R signals of all samples, and map a 1 ch 16-bit signal including 4:2:2 of r:g:b and including a G signal of all samples and B and R signals of even samples, and a 1 ch 16-bit signal including 0:2:2 of r:g:b and including B and R signals of odd samples without a G signal;
a mapping controller configured to map the 1 ch 16-bit signal punctured per word and including 4:2:2 of r:g:b on first and second HD-SDI including 2 ch 10-bit signals including 4:2:2 of r:g:b according to a first mapping structure, and map a 1 ch 16-bit signal punctured per word and including 0:2:2 of r:g:b on third HD-SDI including a 1 ch 10-bit signal including 4:2:2 of r:g:b according to a second mapping structure; and
a reading controller configured to output the first to third HD-SDI; and
a signal receiving device including:
a writing controller configured to write the first to third HD-SDI including 3 ch 10-bit signals, in a memory;
an extraction controller configured to extract the 1 ch 16-bit signal including 4:2:2 of r:g:b, from the first and second HD-SDI read from the memory according to the first mapping structure, and extract a 1 ch 16-bit signal including 0:2:2 of r:g:b, from third HD-SDI including a 1 ch 10-bit signal including 4:2:2 of r:g:b according to the second mapping structure; and
a word multiplexing controller configured to generate the 1 ch 16-bit signal including 4:4:4 of r:g:b by multiplexing per word the 1 ch 16-bit signal including 4:2:2 of r:g:b and the 1 ch 16-bit signal including 0:2:2 of r:g:b.
